(19) United States
(12) Patent Application Publication
(10) Pub. No.: US 2006/0056591 A1
(43) Pub. Date: Mar. 16, 2006

(54) Diagnostic x-ray system

(75) Inventor: Ludger Borgmann, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/534,471

(22) PCT Filed: Nov. 3, 2003
(86) PCT No.: PCT/IB03/04956

§ 371 Date: May 10, 2005

(30) Foreign Application Priority Data
Nov. 14, 2002 (DE) 102 53 057.2

(51) Int. Cl. H05G 1/38

(52) U.S. Cl. 378/96

(57) ABSTRACT

The invention relates to a diagnostic X-ray system which comprises notably a mobile X-ray apparatus (10), a mobile data terminal (30) and a data processing unit (20) for the images acquired by means of the X-ray apparatus (10). The system is characterized notably in that the parameters of an X-ray exposure formed by means of the X-ray apparatus (10) are transmitted, preferably in a wireless fashion, to the mobile patient data terminal (30) in which they are combined with patient data entered by a user as well as with an identification number of the image cassette on which the image is stored, read by means of a bar code scanner (306), so as to form a patient data set. Such a patient data set is then transmitted to the data processing unit (20) in which it is supplemented with the image data which is read from the image cassette so as to be processed. It is thus simply possible to combine all relevant data of an X-ray exposure with one another while eliminating any source of errors at least substantially.

The invention relates to a diagnostic X-ray system which comprises an X-ray apparatus which is notably mobile, a mobile data terminal and a data processing unit for the images acquired by means of the X-ray apparatus, and also relates to a method of operating such a system in respect of the transmission of data within the system.

Generally speaking, in a system of this kind the X-ray apparatus operates in conformity with a digital acquisition method where an acquired image is stored in digital form on a CR (computed radiography) image cassette. After an X-ray exposure the image cassette is removed from the X-ray apparatus and inserted into a cassette reader of a data processing unit which reads the stored image data, processes this data and reproduces it in the form of an X-ray image on a monitor or a display.

In such an environment it is very important that given patient data (name, age, exposure date, etc.) as well as the parameters of the X-ray exposure (settings of the X-ray apparatus, applied dose, etc.) can be unambiguously associated with a given image cassette or the X-ray image stored thereon.

U.S. Pat. No. 5,865,745 discloses an input apparatus with a touch screen and a bar code scanner whereby patient information and/or information concerning an X-ray exposure can be entered, stored and transmitted to a remote device for the processing of a digital X-ray image in order to be associated with the digital X-ray image.

However, this system has the drawback, for example, that errors cannot be precluded, that is, notably not during the manual input via the touch screen. During the input of notably information concerning an X-ray exposure (exposure parameters) by means of the bar code scanner it cannot be precluded either that an incorrect bar code line is entered due to a mix-up, said line then containing data other than the data with which the relevant X-ray exposure has actually been carried out.

The input of information on an X-ray image by means of the bar code scanner, moreover, is not advantageous either in cases where individual exposure parameters are modified so as to optimize the X-ray image, because such individual modifications, of course, cannot be detected via the bar code, but nevertheless are of major importance in respect of the reproducibility of the exposure.

Finally, in the case of automatic exposure control for X-ray exposures such entering of the exposure parameters by way of a bar code is no longer possible at all.

It is an object of the invention, therefore, to provide an X-ray apparatus and a diagnostic X-ray system of the kind set forth whereby the parameters of an X-ray image can be determined in a substantially more accurate and reliable manner.

The invention also aims to provide a diagnostic X-ray system of the kind set forth whereby the parameters of an X-ray exposure can be associated with patient data as well as with the relevant X-ray image in a substantially simpler manner and while the risk of errors or mix-ups is substantially reduced.

The object is achieved by means of an X-ray apparatus as claimed in claim 1, by means of a data processing unit as claimed in claim 2 and by means of a mobile patient data terminal as claimed in claim 3, as well as by means of a diagnostic X-ray system which is formed therefrom in conformity with the claims 6 or 7.

The dependent claims 4 and 5 disclose preferred embodiments of the mobile patient data terminal.

The object is also achieved by means of a method for the transmission of data in such a system as claimed in claim 8.

The dependent claims 9 and 10 relate to preferred versions of the method.

Further details, features and advantages of the invention will become apparent from the following description of preferred embodiments which is given with reference to the drawing. Therein:

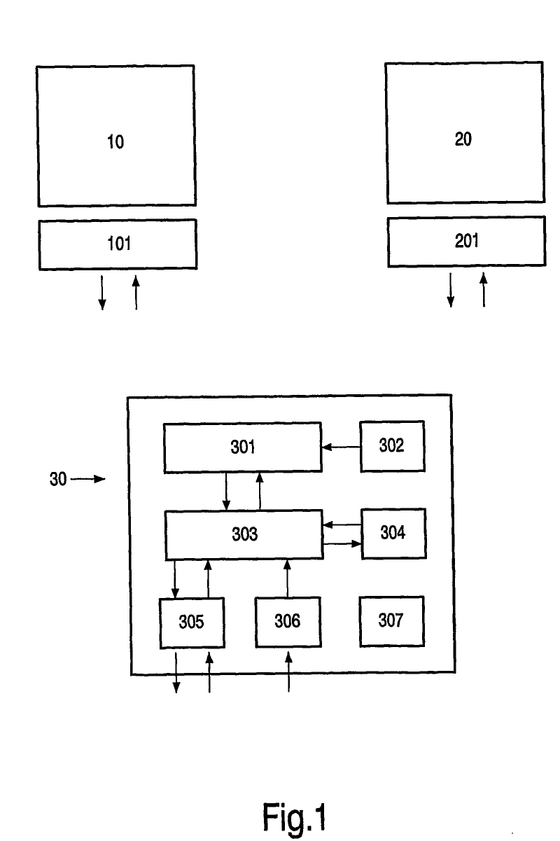

FIG. 1 is a diagrammatic overall representation of a first embodiment of the diagnostic X-ray system in accordance with the invention, and

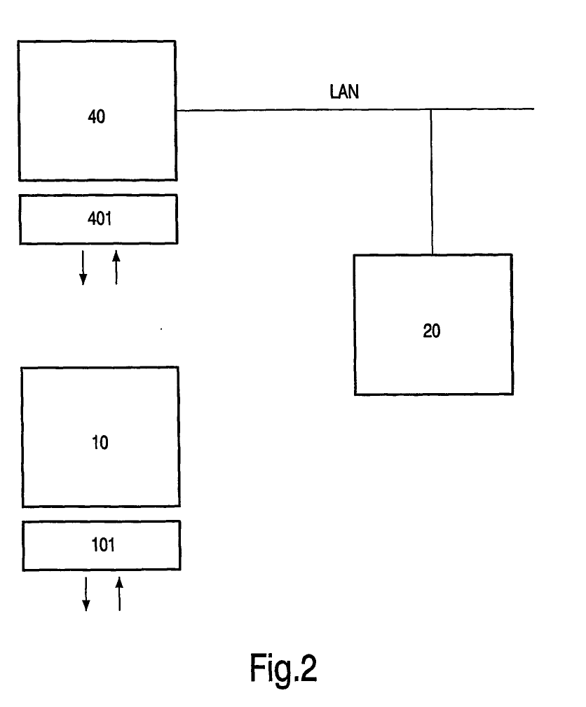

FIG. 2 is a diagrammatic overall representation of a second embodiment of the diagnostic X-ray system in accordance with the invention.

The invention will be described hereinafter on the basis of a diagnostic X-ray system which comprises a mobile X-ray apparatus which carries out a digital image acquisition method and utilizes CR image cassettes on which the image data of an X-ray exposure are stored in digital form (diskette system). In respect of its application, however, the principle of the invention for the transmission of the data between the components of the system is not restricted to mobile X-ray apparatus or digital acquisition methods.

Furthermore, it is not absolutely necessary that the transmission between the components of the system takes place in wireless form. The data can also be transmitted in a wire-bound fashion between two or all three described components.

In conformity with FIG. 1 the components of the diagnostic X-ray system consist of a mobile X-ray apparatus 10, a data processing unit 20 as well as a mobile patient data terminal 30.

The X-ray apparatus 10 comprises the devices necessary for recording a digital X-ray image of a patient on a CR image cassette. The X-ray apparatus 10 also comprises, as an integral component or as an external accessory, a first data transmission unit 101 for the wireless transmission and reception of data to and from the mobile patient data terminal 30. The wireless transmission can be realized by means of electromagnetic waves, by means of light, notably in the infrared range, as well as by means of acoustic waves or in another manner.

The data processing unit 20 per se is also known and comprises notably a cassette reader and a monitor as well as further devices necessary for reading out the image data of an X-ray image stored on a cassette as well as for generating and displaying the X-ray image on the monitor. The data processing unit 20 also comprises, again as an integral component or as an external accessory, a second data transmission unit 201 for the wireless transmission and reception of data to and from the mobile patient data terminal 30. This wireless transmission can again be realized by means of electromagnetic waves, by means of light, notably in the infrared range, as well as by means of acoustic waves or in another manner.

Finally, the system in conformity with FIG. 1 comprises the mobile patient data terminal 30. This terminal 30 has a user surface 301, for example, a TFT display, as well as a keyboard 302 for the input of data by a user. Alternatively, a touch screen could also be provided.

The user surface 301 is driven by a microcontroller 303 which comprises a program memory and is also connected to the data memory 304. The data memory 304 is a non-volatile memory, for example, a hard disk or a battery-powered semiconductor memory.

The terminal 30 also comprises a third data transmission unit 305 which is bi-directionally connected to the microcontroller 303 and serves for the wireless transmission and reception of data to and from the first data transmission unit 101 of the X-ray apparatus 10 as well as to and from the second data transmission unit 201 of the data processing unit 20. This wireless transmission can again be realized by means of electromagnetic waves, by means of light, notably in the infrared range, as well as by means of acoustic waves or in another manner.

Furthermore, the terminal 30 is provided with a bar code scanner 306 which is connected to the microcontroller 303 in order to read a bar code scanned by means of a laser beam.

Finally, a power supply 307 of the terminal 30 is realized in the form of a battery or accumulator unit.

The function of the diagnostic X-ray system as shown in FIG. 1 will be described in detail hereinafter.

It is assumed that a user forms an X-ray image in a customary manner by means of the X-ray apparatus 10, that is, by actuating a start switch. Simultaneously with the actuation of the start switch a software program is started in an arithmetic unit of the X-ray apparatus 10; such a program assembles the selected and/or automatically adjusted parameters of the X-ray image, for example, the kV value, the mAs value, the ms value, the dose value, etc. so as to form a first data set.

This first data set is extended with further information which serves to enhance the protection against errors during the transmission of the data set in the form of a coded serial data stream. This information is, for example, a time stamp which represents the date and the time of the X-ray image, an unambiguous identification number which is associated with the relevant X-ray apparatus (that is, exclusively with this apparatus), as well as a checksum (sum of all transmitted bytes). Furthermore, the first data set is encoded according to a scheme whereby transmission errors can be recognized in known manner and possibly corrected at the bit level (for example, a 4B/5B code).

The first data set (data stream) formed in this manner is subsequently applied to the first data transmission unit 101 in order to modulate therein a carrier frequency of the above kind (electromagnetic waves, light, etc.) so as to be transmitted as a transmission signal.

The first data set can alternatively be formed completely in the first data transmission unit 101 when this unit is provided with an appropriate arithmetic unit and the software program and the parameters of the X-ray exposure and the further information are applied to the first data transmission unit 101 by the X-ray apparatus 10.

The transmission signal is received via an antenna of the mobile patient data terminal 30, is transmitted as a received signal to the third data transmission unit 305 and is demodulated in known manner so that the first data set can be decoded. This takes place essentially in the reverse order in comparison with the procedure carried out in the first data transmission unit 101.

Thus, it is first checked that the code and the checksum do not contain errors and, if necessary, a correction is performed. Subsequently, the identification number of the transmitting X-ray apparatus 10 is compared with the own identification number of the mobile terminal 30 so as to be checked for consistency in order to enable correct association of the received signal with the transmitting X-ray apparatus 10. Furthermore, the date and the time are subjected to a plausibility test. In the absence of plausibility or in the case of errors that cannot be corrected, it is first requested to repeat the transmission of the transmission signal, that is, by transmitting a suitable signal from the third data transmission unit 305 to the first data transmission unit 101. In as far as the new received signal is not plausible or contains errors that cannot be corrected, the further evaluation in the terminal 30 is terminated and the user is informed accordingly by way of a suitable signal.

After the received signal has been recognized as being correct, the parameters of the X-ray exposure which are contained therein are first stored in a storage section of the data memory 304 which serves as a buffer. Because this data memory is constructed so as to be non-volatile, as has already been stated, this data will not be lost should the terminal 30 be accidentally switched off or should the power supply 307 break down.

In parallel therewith the user should enter the patient data and descriptive parameters of the X-ray exposure into the terminal 30 via the keyboard 302 (or a user surface 301 constructed in the form of a touch screen). To this end, a patient data set concerning the relevant patient is formed in a database, said patient data set comprising, for example, the name of the patient, the type of exposure, the date of the exposure, a running unambiguous data set identification number as well as a number of empty fields for the parameters of the X-ray exposure which will be entered later. A plurality of patient data sets of this kind may be stored and organized in the database in such a manner that a mix-up of individual data can be precluded. Finally, the database is stored in the non-volatile data memory 304.

Subsequently, the parameters of the X-ray exposure (first data set), being contained in the received signal and buffered, are to be combined with the data included in the associated patient data set. To this end, the user automatically receives an optical or acoustic request from the terminal 30 he or she is carrying, that is, after the parameters of the X-ray exposure contained in the received signal, having been recognized as being correct, have been stored in the buffer. In response thereto, for example, the user can select, with the aid of a menu displayed on the user surface 301 of the terminal 30, the correct or associated patient data set and add the parameters of the X-ray exposure to this data set. The parameters are then automatically entered into the empty fields provided for this purpose.

The second data set (completed patient data set) thus formed is written into the data memory 304 again as a part of the database, and the buffer memory wherefrom the parameters of the X-ray exposure have been extracted is erased and released for a next exposure.

This release is subsequently signaled to the user by way of a corresponding release signal on the terminal 30. At the same time the release signal is applied, via the third data transmission unit 305, to the first data transmission unit 101 of the X-ray apparatus 10, so that this apparatus is released for a new X-ray exposure.

It is thus ensured that the parameters of the X-ray exposure are first combined with the patient data before a new exposure can be made.

Furthermore, it must be ensured that the second data set formed is unambiguously associated with the relevant X-ray exposure which is still stored in digital form on the image cassette.

To this end, each image cassette is provided with an unambiguous identification number in the form of a bar code which can be read by means of the bar code scanner 306 of the terminal 30. When an appropriate test reveals that the bar code read is correct, the code is decoded and the relevant identification number is buffered in a section of the non-volatile data memory 304. The foregoing is signaled to the user by means of an optical or acoustic signal.

Before or after this read operation, the user selects the associated second data set on the terminal 30. The buffered identification number of the image cassette is then combined with the second data set in that it is entered into the empty position provided for this purpose in the second data set. The third data set (completed patient data set) thus formed is subsequently stored in the data memory 304 as part of the database and comprises the following data in the present example:
name of the patient, type of X-ray exposure, the parameters of this X-ray exposure, the associated identification number of the image cassette, the date of the exposure as well as an unambiguous identification number of the data set.

After the formation of the third data set, the image cassette can be inserted into the cassette reader of the data processing unit 20 which is generally situated in a location remote from the X-ray apparatus 10.

Upon request by the user (for example, by actuation of a button on the terminal 30) the third data set, stored in the terminal 30, is then transmitted to the second data transmission unit 201 by means of the third data transmission unit 305. This operation is performed by modulation or demodulation with a carrier frequency, that is, in the manner already described for the transmission of the first data set from the first data transmission unit 101 to the third data transmission unit 305.

The received signal is thus checked for correctness, consistency and plausibility and possibly subjected to error correction. In as far as necessary, the third transmission unit 305 is requested to repeat the transmission. Subsequently, a data set which is a copy of the third data set formed in the terminal 30 is formed from the received signal and stored in a corresponding database in the data processing unit 20.

In the same way as for the formation of the first data set, an arithmetic unit with a software program may be again provided for such processing. Moreover, this arithmetic unit may also form part of the second data transmission unit 201; in that case the third data set, recovered from the received signal, is applied to the data processing unit 20 by the second data transmission unit 201.

Furthermore, in parallel therewith the image data stored on the image cassette is read and used in known manner for calculating a correct and artifact-free image which can be displayed on the monitor or the display of the data processing unit 20 or be printed.

For identification the identification number provided in the form of the bar code on the film cassette is assigned to the calculated image by reading it by means of a bar code scanner provided in the cassette reader.

Subsequently, on the basis of this image cassette identification number the third data set associated with the image is read from the database of the data processing unit 20. This third data set is then supplemented with the data of the calculated image, so that all data of an exposure, including that of the image per se, have been combined without gaps and in a consistent manner.

Before the erasure of the digital image stored on the image cassette and the release of the cassette for a new exposure, the calculated image is subjected to a visual inspection for errors. When the image is reproduced without errors (meaning that it has been correctly calculated or has been suitably corrected in the desired form), the image cassette identification number is released for a next exposure and also removed from the third data set. This results in a fourth data set which is intended for further processing or for filing; such a fourth data set contains the following data: patient name, type of exposure, the image data per se, the associated parameters of the X-ray exposure, the date of the exposure as well as an unambiguous data set identification number.

An alternative embodiment of the described diagnostic X-ray system does not comprise a mobile patient data terminal 30. In that case there are provided one or more X-ray apparatus 10, comprising each time a respective first data transmission unit 101, constructed so as to be integral or as an accessory, as well as one (or possibly more) data processing units 20 with a data transmission unit 201 which is integral or constructed as an accessory.

The transmission of the first data set, containing the parameters of the X-ray exposure, then takes place directly from the first data transmission unit 101 to the second data transmission unit 201, and the described entries by the user via the mobile data terminal 30 are now made directly on the data processing unit 20.

The remainder of the processing is the same as described above, so that the fourth data set is again formed so as to comprise the following data: patient name, type of exposure, the image data per se, the associated parameters of the X-ray exposure, the date of the exposure as well as an unambiguous data set identification number. In the case where the data processing unit 20 in conformity with FIG. 2 is installed in a comparatively remote location and is connected, for example, to a local network (LAN), if necessary the first data set can be applied directly, while bypassing the mobile data terminal 30, from the first data processing unit 101 of the (mobile) X-ray apparatus 10 to a fourth data transmission unit 401 which is connected to an access unit (access point) 40 which is connected to the local network LAN. The fourth data transmission unit can again be constructed as an integral part of such an access unit 40. The received first data set is transmitted by the access unit 40, via the local network LAN, to the data processing unit 20 so that therein the fourth data set can be formed again in the described manner.

1. An X-ray apparatus (10) which comprises a first data transmission unit (101) for generating and transmitting a first data set which comprises selected and/or automatically adjusted parameters of an X-ray exposure to a further data transmission unit (201; 305; 401).

2. A data processing unit (20) for processing the image data of an X-ray exposure made by means of an X-ray apparatus (10), which data processing unit comprises a second data transmission unit (201) for receiving a first data set which comprises at least the selected and/or automatically adjusted parameters of the X-ray exposure as well as for forming a fourth data set which comprises an association between the parameters of the X-ray exposure, predetermined patient data as well as the image data of the X-ray exposure.

3. A mobile patient data terminal (30) which comprises a third data transmission unit (305) for receiving a first data set which comprises the selected and/or automatically adjusted parameters of an X-ray exposure as well as for forming a second data set whereby predetermined patient data is associated with the parameters of the X-ray exposure.

4. A mobile patient data terminal (30) as claimed in claim 3, comprising a bar code scanner (306) for detecting an image cassette identification number as well as for forming a third data set by adding the image cassette identification number to the second data set.

5. A mobile patient data terminal (30) as claimed in claim 4, in which the third data transmission unit (305) is arranged to transmit the third data set formed to a data processing unit (20) as claimed in claim 2.

6. A diagnostic X-ray system which comprises a mobile X-ray apparatus (10) as claimed in claim 1, and including a data processing unit (20).

7. A system as claimed in claim 6, further comprising a mobile patient data terminal (30).

8. A method for the transmission of data in a diagnostic X-ray system, notably as claimed in claim 6, in which subsequent to the execution of an X-ray exposure in an X-ray apparatus (10) the parameters selected and/or automatically adjusted for the X-ray exposure are combined so as to form a first data set which is transmitted to a further component (20; 30) of the system.

9. A method as claimed in claim 8, in which the first data set formed by the X-ray apparatus (10) is transmitted to a mobile patient data terminal (30) and a third data set is formed therefrom, which third data set comprises the parameters of the X-ray exposure, preselectable patient data as well as an identification number of the image cassette on which the relevant X-ray exposure is stored.

10. A method as claimed in claim 9, in which the third data set formed by the mobile patient data terminal (30) is transmitted to a data processing unit (20) and a fourth data set is formed therefrom, which fourth data set comprises the parameters of the X-ray exposure, preselectable patient data as well as the image data of the X-ray exposure.
